(19) United States
(12) Patent Application Publication
(10) Pub. No.: US 2013/0142332 A1
(43) Pub. Date: Jun. 6, 2013

(54) VOICE AND SCREEN CAPTURE ARCHIVE AND REVIEW PROCESS USING PHONES FOR QUALITY ASSURANCE PURPOSES

(71) Applicants: Andrés Ramos, Capital Federal (AR); Damian Nardelli, Haedo Moron (AR); Pablo Barsotti, Buenos Aires (AR); Bruce Sharpe, Aurora, CO (US)

(72) Inventors: Andrés Ramos, Capital Federal (AR); Damian Nardelli, Haedo Moron (AR); Pablo Barsotti, Buenos Aires (AR); Bruce Sharpe, Aurora, CO (US)

(21) Appl. No.: 13/707,519

(22) Filed: Dec. 6, 2012

Related U.S. Application Data
(60) Provisional application No. 61/567,452, filed on Dec. 6, 2011.

(51) Int. Cl. H04N 7/167

(52) U.S. Cl. CPC H04N 7/167
USPC 380/236

(57) ABSTRACT

A voice and screen capture archive and review process that enables a user to manage and evaluate customer service representative interactions with customers. An audio recording and a video recording of the computer screen of the customer service representative are captured and encrypted and merged together into a formatted file. The formatted file is stored on a storage server for access by the user. Through a web based API, the user can access the stored files and playback the interaction between the customer service representative and the customer for evaluation and training purposes.

### CROSS-REFERENCES TO RELATED APPLICATIONS

This application claims the benefit of U.S. Provisional Application Ser. No. 61/567,452 filed on Dec. 6, 2011, titled “VOICE AND SCREEN CAPTURE ARCHIVE AND REVIEW PROCESS USING PHONES FOR QUALITY ASSURANCE PURPOSES” which is incorporated herein by reference in its entirety for all that is taught and disclosed therein.

### TECHNICAL FIELD

This invention generally relates to monitoring interaction between individuals, and more particularly to interaction between customer service representatives and customers.

### BACKGROUND

A customer service session typically involves a customer interacting with a customer service representative over a teleconference. Oftentimes, a company on behalf of which the session is being conducted will monitor the interaction between the customer service representative and the customer for external as well as internal purposes. For example, an external purpose relates to providing documentation of the interaction in the case that the customer or customer service representative later disputes any agreements or promises made during the session. Such recordation provides an invaluable tool, especially when the interaction involves the sale of a good or service. An example of an internal purpose relates to providing documentation of the interaction for use in later performing a quality assurance assessment of the session or otherwise evaluating the efficiency and demeanor of the customer service representative.

Originally, customer service sessions were monitored using audio recorders positioned in close relation to the customer service representative's office space. As a customer call was connected to the customer service representative's phone, the customer service representative would be responsible for initiating a recording session and maintaining that recording session until completion of the call. Modern systems, however, are much more advanced and shift the responsibility of initiating recording sessions from the customer service representative to a computer.

FIG. 1, for example, illustrates a conventional computer-based monitoring system 100 for use in documenting interaction between a customer service representative and a customer. Customer service sessions are typically initiated by a customer calling a customer service representative using a phone 102. Once dialed, the call is connected to a customer service representative's phone 106 by way of the Public-Switched Telephone Network (PSTN) 104.

As is common with large companies, a number of customer service representatives are employed to take customer service calls, however, at any given time, very few or none might be available. Therefore, an automatic control distribution (ACD) module 108 may be used to accept customer service calls from the PSTN 104 and select the most appropriate customer service representative for interaction with the calling customer. Oftentimes, the most appropriate customer service representative will be selected from an available customer service representative or, if all customer service representatives are currently busy with other customers, the customer service representative having the shortest queue (assuming that a number of other calling customers are on hold). The ACD module 108 serves as a gateway into the company's internal network from the PSTN 104 and is thus assigned a specific telephone number for accepting calls on behalf of the company's customer service department.

The monitoring system 100 includes an audio recording component 112, a scheduling component 114, a video capture device 116 for each customer service representative, two databases 118 and 120 and a server computer 122. A first database 118 of the two databases stores video data captured from the video capture devices 116 while the other database 120 stores audio data captured by the audio recording component 112, as shown using data communication lines 126 and 130, respectively. Each video capture device 116 is positioned relative to a customer service representative in order to record the movements and actions of the customer service representatives during service sessions. The audio recording component 112 is communicatively connected to the ACD module 108 by way of a first data communication link 124, such as a T1 transmission line. The scheduling component 114 is communicatively connected to the ACD module 108 by way of a second data communication link 126, which is referred to as a CTI link.

In response to receiving a call on the PSTN 104, the ACD module 108 selects the appropriate customer service representative based on any number of considerations (as described above) and transmits a signal over the CTI link 126 to the scheduling module 114 that identifies the selected customer service representative. The scheduling module 114 determines whether the selected customer service representative is due for monitoring and, if so, instructs the audio recording component 112 and the video capture device 116 associated with the selected customer service representative to record the service session between the customer and the selected customer service representative.

Furthermore, the scheduling component 114 instructs the ACD module 108 via the CT1 line 126 that the current session has been selected for recording and, in response to such instruction, the ACD module 108 provides an audio feed of the entire conversation to the audio recording component 112 over the T1 line 124. When it is desired to record a call a command is sent to the switch to observe the call and request the audio to be sent to the server computer 122.

Audio data recorded by the audio recording component 112 is saved to the audio database 120 and video data recorded by the video capture device 116 is saved to the video database 118. More specifically, for each recorded service session, the audio database 120 stores an audio file documenting the vocal interaction between the customer and selected customer service representative. Likewise, the video database 118 stores a video file for each recorded service session that documents the actions and movements of the selected customer service representative.

The server computer 122, which is communicatively connected to both the audio and video databases 118 and 120 via the playback server 121, is used by supervisors to monitor recorded service sessions. To provide functionality for monitoring a specific service session, the server computer 122 first accesses the playback server 121 and requests playback of the service session. The playback server 121 retrieves the corresponding audio file from the audio database 120 and the corresponding video file from the corresponding video database 118 and thereafter streams them to the server computer 122 concurrently with one another such that the supervisor is provided with both video and audio documentation of the specified service session at the same time.

While computer-based monitoring certainly has advantages over the prior manual approach, there is room for much improvement. For example, the intended simultaneous playback of audio and video files on the server computer 122 is often out of synch. With that said, the video playback often lags behind the audio playback or, vice-versa. Furthermore, current monitoring systems, such as the system 100 shown in FIG. 1, are off-the-shelf type systems that include either unnecessary features or, alternatively, lack required features. While unnecessary features tend to slow down certain processing functions thereby bogging down the system altogether, systems that lack features are typically incompatible with certain implementations.

Another prior art improvement is generally related to monitoring interaction between individuals engaged in a communication session. The communication session is accomplished over a communication network, to which the individuals are communicatively connected by way of communication devices. More particularly, the prior art improvement involves recording both interactive data and activity data concerning the communication session and storing both forms of data in association with one another in a single media file. The interactive data embodies information concerning the communication between the individuals such as, without limitation, voice or other audio information, email information and chat information. Accordingly, the communication devices used by the individuals may be phones, email client applications or chat client applications. The activity data embodies information concerning a physical activity by one or both of the individuals such as, for example, video camera recordings (e.g., physical movement of an individual), computer screen activities, mouse movements and keyboard actions. The media file is saved and made available for future playback purposes. For example, if the media file documents interaction between a customer service representative and a customer, then future playback may be desired for quality assurance and other forms of evaluation.

An embodiment of the prior art improvement is practiced as a method that involves receiving the interactive data during transmission between the communication network and a communication device used by an individual participating in the communication session. The method further includes capturing activity data that embodies actions and movements by that same individual during the session. In receipt of both forms of data, the method involves associating segments of the interactive data with segments of the activity data according to a common time reference thereby substantially synchronizing the interactive data and the activity data for subsequent playback.

In another embodiment, the prior art improvement relates to a system for monitoring interaction of an individual that participates in communication sessions with other individuals over a communication network. This system has, among other things, a monitoring module, a client computer and a media file. The monitoring module selects specific communication sessions directed to the individual for recording. The client computer is communicatively connected to the communication network as well as to any communication devices used by the individual to participate in the communication sessions. As such, the client computer receives and copies any interactive data transmitted between the communication device and the communication network. The client computer also includes an activity capture application operable to monitor activity data concerning the recorded communication session.

The media file includes the interactive data copied by the client computer during a selected communication session as well as the activity data recorded by the client computer during that same communication session. Also, the interactive data and the activity data are synchronized in the media file according to a common time reference. In accordance with this embodiment, the system may also include a server computer on which the media file is played back for various types of monitoring purposes.

The various embodiments of the prior art improvement may be implemented as a computer process, a computing system or as an article of manufacture such as a computer program product or computer readable media. The computer program product may be computer storage media readable by a computer system and encoding a computer program of instructions for executing a computer process. The computer program product may also be a propagated signal on a carrier readable by a computing system and encoding a computer program of instructions for executing a computer process.

The prior art improvement is generally directed to monitoring interaction between individuals for future evaluation or documentation purposes. With that said, an exemplary embodiment involves monitoring interactions between a customer and a customer service representative and, the prior art improvement is hereinafter described as such. The customer service representative may be employed on behalf of a company to communicate with customers in any capacity involving any matter pertaining to the company. For example, the customer service representative may discuss sales, product support as well as service or product installation with a customer and these exemplary interactions may be the subject of monitoring in accordance with the prior art improvement.

With the general environment in which embodiments of the prior art improvement are applicable provided above, FIG. 2 depicts, in block diagram form, a system 200 for monitoring (hereinafter, “monitoring system”) communication sessions between a customer and a customer service representative in accordance with an embodiment of the prior art improvement. The monitoring system 200 includes a monitoring module 202, a client computer 206 (hereinafter, “agent terminal”), which is assigned to each customer service representative and on which is implemented an interactive data recording application 230 and an activity recording application 232, a Voice Over Internet Protocol (VOIP) soft phone 208 (optional) connected to each agent terminal 206, a video capture device 210 (optional) also connected (by video card) to each agent terminal 206, an internal communication network 204 (hereinafter, “intranet”), a database 220 and a server computer 222. For illustration purposes, the monitoring system 200 is shown in FIG. 2 and described relative to monitoring only one customer service representative, however, it should be appreciated that numerous customer service representatives may be monitored and thus, any number of agent terminals 206 (including interactive data recording applications 230 and activity recording applications 232), VOIP phones 208 (optional) and video capture devices 210 (optional) are contemplated to be part of the monitoring system 200.

The monitoring module 202 manages overall implementation of the system 200 and, in accordance with an embodiment, is implemented as a software application residing in a computing environment, an exemplary depiction of which is shown in FIG. 4 and described below in conjunction therewith. With that said, the computing environment may be made up of the agent terminal 206, the server computer 222 and/or a central server computer (not shown), each of which are communicatively connected with one another by way of the intranet 204. If the monitoring module 202 is implemented on or otherwise accessible to more than one of these computing systems, the environment is coined a “distributed” computing environment. Because the monitoring module 202 may be implemented on or otherwise accessible to any one or more of these computing systems, the monitoring module 202 is shown in FIG. 2 in general form using a block and dashed lines. Indeed, the prior art improvement is not limited to any particular implementation for the monitor module 202 and instead embodies any computing environment upon which functionality of the monitoring module 202, as described below and in conjunction with FIGS. 5 and 6, may be practiced.

The intranet 204 may be any type of network conventionally known to those skilled in the art and is described in accordance with an exemplary embodiment to be a packet-switched network (e.g., an Internet Protocol (IP) network). As such, the monitoring module 202, the agent terminal 206 and the server computer 222 are each operable to communicate with one another over the intranet 204 according to one or more standard packet-based formats (e.g., H.323, IP, Ethernet, ATM).

Connectivity to the intranet 204 by the agent terminal 206, the monitoring module 202 and the server computer 222 is accomplished using wire-based communication media, as shown using data communication links 212, 214 and 216, respectively. The data communication links 212, 214 and 216 may additionally or alternatively embody wireless communication technology. It should be appreciated that the manner of implementation in this regard is a matter of choice and the prior art improvement is not limited to one or the other, but rather, either wireless or wire-based technology may be employed alone or in combination with the other.

Each customer service representative is provided an agent terminal 206 that is communicatively connected to an ACD 108 by a communication link 201 (again, either wireless or wire-based) in accordance with an embodiment of the prior art improvement. Alternatively, the ACD 108 may communicate with the agent terminal 206 by way of the intranet 204. In response to receiving an incoming call, the ACD 108 selects the appropriate customer service representative based on any number and type of considerations (e.g., availability, specialty, etc.) and connects the call to the corresponding agent terminal 206.

In addition, the ACD 108 serves as a packet gateway, or “soft switch,” which converts the incoming Time Division Multiple Access (TDMA) signals from the PSTN 104 into a packet-based format according to one or more standards (e.g., H.323, IP, Ethernet, ATM), depending on the level of encapsulation desired within the monitoring system 200. The audio information accepted from the PSTN 104 is therefore provided to the agent terminal 206 in packets 203 that may be interpreted by the agent terminal 206, which as noted above is a computer system.

The VOIP phone 208 and the video capture device 210 (if utilized) are both communicatively connected to input/output ports (e.g., USB port, fire wire port, video card in PCI slot, etc.) on the agent terminal 206 by way of data communication lines 211 and 213. In an embodiment, the agent terminal 206 is a desktop computer having a monitor 207 and a keyboard 209 in accordance with an exemplary embodiment, but alternatively may be a laptop computer. As noted above, the agent terminal 206 includes two software applications for use in administering embodiments of the prior art improvement—the interactive data recording application 230 and the activity recording application 232. The interactive data recording application 230 records communications between customers and the customer service representative assigned to the agent terminal 206. For example, the interactive data recording application 230 records any voice data packets transmitted between the ACD 108 and the VOIP phone 208. Additionally, the interactive data recording application 230 may record any other audio information, email information or chat information embodying interaction between the customer and the customer service representative. The activity recording application 232 records various forms of activity performed by the customer service representative assigned to the agent terminal 206 during such customer interaction. For example, the activity recording application 232 receives and records video data via activity transmitted from the video card and, in an embodiment, also monitors other forms of information such as, for example, computer screen activities, mouse movements and keyboard actions.

Briefly describing functionality of the monitoring system 200 relative to phone communications, after selecting a customer service representative to accept a service call, the ACD module 108 begins converting the audio information embodied in the service call to the packet-based format and streaming the resulting packets 203 to the agent terminal 206. Concurrently, the monitoring module 202 detects incoming packets to the agent terminal 206 and determines whether the selected customer service representative is due for recording. Various factors may go into such a determination and the prior art improvement is not limited to any particular factors. Indeed, in some embodiments, each customer service representative is recorded on a periodic basis (e.g., every tenth service session), whereas in other embodiments, all sessions with one or more particular customer service representatives are recorded.

Regardless of the manner of implementation, if the monitoring module 202 determines that the selected customer service representative is due for recording, then the monitoring module 202 informs the interactive data recording application 230 to create an empty media file on the agent terminal 206 for use in storing data recorded during the service session. In an embodiment, the blank, or “skeleton,” media file is created on the agent terminal 206 and embodies a data structure that will store both the interactive data and the activity data recorded during the service session. In accordance with an exemplary embodiment, the interactive data is described in connection with this illustration as embodying the audio communication (e.g., voice data) between the customer and the selected customer service representative and, in an embodiment, is divided into a plurality of contiguous segments of a predetermined size (corresponding to predetermined length in time). The activity data includes information documenting activities of the customer service representative working at the monitored agent terminal 206 during the customer service session. Such information includes, but is not limited to, screen activities, mouse movements, keyboard actions, video camera recordings and any other internal or external device activity. Like the interactive data, the activity data is also divided into a plurality of contiguous segments of the same predetermined size (corresponding to predetermined length in time) as the interactive data segments to provide for facilitated synchronization. A more detailed explanation of receiving and storing the interactive data and the activity data is provided below in conjunction with FIG. 6.

After the media file is created, the monitoring module 202 begins copying the interactive data from both incoming (i.e., carrying customer voice data) and outgoing (i.e., carrying customer representative voice data) packets 203 and storing the copied interactive data to the media file while, at substantially the same time, instructs the activity recording application 232 to begin recording the customer service representative's activity, the output from which is also directed to the media file. To illustrate, an exemplary embodiment involves the activity recording application 232 receiving and records video data from the video capture device 210, wherein the video data documents movement and physical activity of the customer service representative during the recorded customer service session. After the interactive data has been copied from the packets 203, the agent terminal 206 outputs the packets 203 to either the VOIP phone 208 or to the ACD module 108, depending on whether the packet is an incoming packet or an outgoing packet.

An exemplary representation 300 of the relation between interactive data and activity data in a media file is shown in FIG. 3 in accordance with an embodiment of the prior art improvement. Again, for illustration purposes only, the interactive data is described in the illustration of FIG. 3 as being audio data embodying voice communications between a customer and a customer service representative and the activity data is described as embodying video data from the video capture device 210. As repeatedly mentioned above, other forms of interactive data and activity data are certainly contemplated to be within the scope of the prior art improvement.

The representation 300 shown in FIG. 3 illustrates that the media file is made up of a plurality of audio segments 302, which in an embodiment are separately embodied in incoming audio sub-segments 302a and outgoing audio sub-segments 302b, and a plurality of video segments 304, each of which are associated with one another by a time reference 306. In accordance with this embodiment, these time associations (i.e., time references 306) between the audio segments 302 and the video segments 304 are established by the monitoring module 202 as the segments 302 and 304 are being received by the agent terminal 206. Accordingly, the video segments 304 and the audio segments 302 are synchronized based on a common time reference, which in an exemplary embodiment, is a clock on the agent terminal 206. Additionally, the monitoring module 202 identifies each media file with a specific identifier that uniquely identifies both the customer service representative and the particular service session for which the file has been created. For example, the file name for the media file may be used to associate the media file with such a unique identification.

Media files are uploaded by the interactive data recording application 230 from the agent terminals 206 to the storage unit for storage and subsequent access by the server computer 222. The monitoring module 202 and the transfer/encoding server update the database 220 with the location and status of the recorded file. In an embodiment, the monitoring module 202 instructs the interactive data recording application 230 to administer media file uploads to the transfer server at the completion of each recorded service session. Alternatively, the interactive data recording application 230 may perform media file uploads to the transfer servers at the conclusion of a plurality of specified time intervals. Even further, interactive data recording application 230 may accomplish media file uploading to the transfer/encoding servers in real-time such that the agent terminal 206 administers the continuous transmission of the audio and the video data to the transfer/encoding servers during recorded service sessions.

The server computer 222 is used by supervisors to monitor interaction between customer service representatives and customers by viewing recorded service sessions. The server computer is communicatively connected to the monitoring module 202 (note: this can also be a separate server which houses the website and is called an IIS Server) by way of the intranet 204. Alternatively, the server computer 222 may be provided a direct communication link 223 to the monitoring module 202 (note: this can also be a separate server which houses the website and is called an IIS Server). Regardless of the means of connectivity, the server computer 222 is operable for use by a supervisor to request a stored media file for playback. The monitoring module 202 impersonates authentication with a service account and communicates to the streaming server (may also be on the same server as the monitoring module) the request to stream data back to the server computer 222. A direct one-way communication is established between the streaming server and the server computer 222.

In addition, a supervisor may use the server computer 222 to monitor interaction between customer service representatives and customers in substantially real-time fashion. In accordance with this embodiment, the media file (including the recorded and time-associated interactive data and activity data) is streamed from the agent terminal 206 to a publishing point. Alternatively, in accordance with this embodiment, the interactive data and the activity data may be streamed to the publishing point from the agent terminal 206 in the form of raw data. In this embodiment, the raw interactive data and raw activity data are first streamed to streamer component (a software module component of the monitoring module 202) that performs the appropriate time association between the two forms of data thereby creating the media file for the session being recorded. Regardless of the implementation, the supervisor uses the server computer 222 to subscribe to the publishing point and remotely monitor customer service sessions as they occur.

In an embodiment, the media files are identified and also categorized in the database 220 based on one or all of the following: the customer service representative; the calendar date (and, optionally time) that the media file was created; DNIS; ANI; Start Time; and Stop Time. Accordingly, selection of the appropriate media file by the supervisor is a matter of selecting that file from a logically categorized group of files in the database 220 (e.g., by way of GUI). It should be appreciated that any conventional database retrieval application may be utilized to provide a front-end selection service for retrieving media files from the database 220 for playback on the server computer 222. Indeed, it is contemplated that such functionality may be programmed into the monitoring module 202.

An exemplary operating environment on which the monitoring module 202 is at least partially implemented encompasses a computing system 400, which is generally shown in FIG. 4. Data and program files are input to the computing system 400, which reads the files and executes the programs therein. Exemplary elements of a computing system 400 are shown in FIG. 4 wherein the processor 401 includes an input/output (I/O) section 402, a microprocessor, or Central Processing Unit (CPU) 403, and a memory section 404. The prior art improvement is optionally implemented in this embodiment in software or firmware modules loaded in memory 404 and/or stored on a solid state, non-volatile memory device 413, a configured CD-ROM 408 or a disk storage unit 409.

The I/O section 402 is connected to a user input module 405, a display unit 406, etc., and one or more program storage devices, such as, without limitation, the solid state, non-volatile memory device 413, the disk storage unit 409, and the disk drive unit 407. The solid state, non-volatile memory device 413 is an embedded memory device for storing instructions and commands in a form readable by the CPU 403. In accordance with various embodiments, the solid state, non-volatile memory device 413 may be Read-Only Memory (ROM), an Erasable Programmable ROM (EPROM), Electrically-Erasable Programmable ROM (EEPROM), a Flash Memory or a Programmable ROM, or any other form of solid state, non-volatile memory. In accordance with this embodiment, the disk drive unit 407 may be a CD-ROM driver unit capable of reading the CD-ROM medium 408, which typically contains programs 410 and data. Alternatively, the disk drive unit 407 may be replaced or supplemented by a floppy drive unit, a tape drive unit, or other storage medium drive unit. Computer readable media containing mechanisms (e.g., instructions, modules) to effectuate the systems and methods in accordance with the prior art improvement may reside in the memory section 404, the solid state, non-volatile memory device 413, the disk storage unit 409 or the CD-ROM medium 408. Further, the computer readable media may be embodied in electrical signals representing data bits causing a transformation or reduction of the electrical signal representation, and the maintenance of data bits at memory locations in the memory 404, the solid state, non-volatile memory device 413, the configured CD-ROM 408 or the storage unit 409 to thereby reconfigure or otherwise alter the operation of the computing system 400, as well as other processing signals. The memory locations where data bits are maintained are physical locations that have particular electrical, magnetic, or optical properties corresponding to the data bits.

In accordance with a computer readable medium embodiment of the prior art improvement, software instructions stored on the solid state, non-volatile memory device 413, the disk storage unit 409, or the CD-ROM 408 are executed by the CPU 403. Data used in the analysis of such applications may be stored in memory section 404, or on the solid state, non-volatile memory device 413, the disk storage unit 409, the disk drive unit 407 or other storage medium units coupled to the system 400.

In accordance with one embodiment, the computing system 400 further comprises an operating system and one or more application programs. Such an embodiment is familiar to those of ordinary skill in the art. The operating system comprises a set of programs that control operations of the computing system 400 and allocation of resources. The set of programs, inclusive of certain utility programs, also provide a graphical user interface to the user. An application program is software that runs on top of the operating system software and uses computer resources made available through the operating system to perform application specific tasks desired by the user. The operating system is operable to multitask, i.e., execute computing tasks in multiple threads, and thus may be any of the following: any of Microsoft Corporation's “WINDOWS” operating systems, IBM's OS/2 WARP, Apple's MACINTOSH OSX operating system, Linux, UNIX, etc.

In accordance with yet another embodiment, the processor 401 connects to the intranet 204 by way of a network interface, such as the network adapter 411 shown in FIG. 4. Through this network connection, the processor 401 is operable to transmit within the monitoring system 200, as described, for example, in connection with the agent terminal 206 transmitting media files to the database 220.

With the computing environment of FIG. 4 in mind, logical operations of the various exemplary embodiments described below in connection with FIGS. 5 and 6 may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the exemplary embodiments described herein are referred to variously as operations, structural devices, acts or modules. It will be recognized by one skilled in the art that these operations, structural devices, acts and modules may be implemented in software, in firmware, in special purpose digital logic, and/or any combination thereof without deviating from the spirit and scope of the present disclosure as recited within the claims attached hereto.

Turning now to FIG. 5, a process 500 for recording interaction between a customer service representative and a customer is shown in accordance with an embodiment of the prior art improvement. The recording process 500 embodies a sequence of computer-implemented operations practiced by a combination of components in the monitoring system 200, including the interactive data recording application 230, the activity recording application 232 and the monitoring module 202, the latter of which is implemented on either a stand-alone computer system, e.g., the agent terminal 206, the server computer 222 or a central server computer (not shown), or a distributed computing environment that includes one or more of these stand-alone systems interconnected with one another by way of the intranet 204.

Furthermore, although only a single agent terminal 206 is shown in FIG. 2 for simplicity, it should be appreciated and understood that the monitoring system 200 is applicable to monitor numerous customer service representatives and, therefore, any number of agent terminals 206 are contemplated within the scope of the prior art improvement. The monitoring module 202 may therefore be implemented in whole or in part on each of these numerous agent terminals 206 (or, alternatively, on a central server computer as noted above). Regardless of the actual environment on which the monitoring module 202 is implemented, the recording process 500, unlike the system description above, is described below with reference to a multiplicity of agent terminals 206.

Consistent with the exemplary illustrations described in connection with FIGS. 2 and 3, the recording process 500 is described below with reference to recording interactive data embodying voice communications between the customer and the customer service representative assigned to the user terminal 206. Likewise, the activity data is described in connection with this illustration as being video data embodying movements and physical activities by the customer service representative during the customer service session being recorded. It should be appreciated that other forms of interactive data, e.g., email and chat information, and activity data, e.g., computer screen activity, mouse actions and keyboard actions, are certainly contemplated to be within the scope of the prior art improvement.

The recording process 500 is performed using an operation flow that begins with a start operation 502 and concludes with a finish operation 512. The operation flow of the recording process 500 is initiated in response to the ACD module 108 directing a customer's service call to a specific customer service representative, at which time the start operation 502 passes the operation flow to a query operation 504. In an embodiment, the start operation 502 detects that a specific customer service representative has been selected for a service session by detecting and examining identification and/or signaling data (e.g., G.729 information) embodied in a first packet 203 of the service call received at the associated agent terminal 206.

The query operation 504 determines whether the selected customer service representative is due for recording. In an embodiment, customer service representatives are recorded on a periodic basis defined by a specified interval. The interval may be a time interval or an interval based on the number of service sessions since the last recorded service session for a particular customer service representative. In this embodiment, the query operation 504 determines the last time that the selected customer service representative has been recorded and, if this recording was not made within the specified interval, then the query operation 504 identifies the selected customer service representative as being due for recording.

In another embodiment, customer service representatives may be recorded pursuant to a request from a supervisor, and in this embodiment, the query operation 504 determines whether such a request has been made. For example, requests to record a specific customer service representative may be entered into the monitoring module 202 by way of the server computer 222. Therefore, when selected for a service call, the query operation 504 identifies the selected customer service representative as being due for recording. In yet another embodiment, all service calls directed to one or more of the customer service representatives may be scheduled for recording, and in this embodiment, the query operation 504 recognizes the selected customer service representative as one of the representatives that are due for permanent recording and identifies him/her as such. Regardless of the embodiment employed, if the selected customer service representative is due for recording, the operation flow is passed to a create operation 506. Otherwise, the operation flow concludes at the finish operation 512.

The create operation 506 creates an empty, or “skeleton,” media file for storing the interactive data and the activity data recorded during the instant service session. As described above with reference to the system environment, the media file is a data structure that will embody both the audio recordings (i.e., interactive data) and the video recordings (i.e., activity data) of the service session between the selected customer service representative and the customer. As described herein for illustrative purposes, the create operation 506 involves creating and storing the media file in the memory of the agent terminal 206 until such time that the media file is uploaded to the database 220. In an alternative embodiment, however, the media file may be created in the database 220 and, as the interactive data and the activity data is received into the agent terminal 206, both forms of data are synchronized with one another and streamed in substantially real-time to the database 220. After the empty media file has been created, the operation flow passes to a data capture operation 508.

The data capture operation 508 captures the activity data recorded by the video capture device 210 and the interactive data carried in the payload of the packets 203 that are incoming and outgoing to the agent terminal 206 assigned to the selected customer service representative. The data capture operation 508 also stores both the interactive data and the activity data to the media file in synchronized fashion such that each segment of interactive data is associated by time reference with a segment of activity data, as illustratively shown in FIG. 3. The data capture operation 508 is described in greater detail in FIG. 6 in accordance with an exemplary embodiment of the prior art improvement. At the conclusion of the service session, the data capture operation 508 passes the operation flow to an upload operation 510.

In accordance with an embodiment, the upload operation 510 maintains the media file on the agent terminal 206 until the specified time for uploading to the database 220. As described above with reference to the system environment, such timing may be specified to take place at the conclusion of each recorded service session or, alternatively, after every specified number of recorded service sessions. At the specified time, the upload operation 510 uploads the media file to the database 220 for storage and subsequent access by the server computer 222. From the upload operation 510, the operation flow concludes at the finish operation 512.

Turning now to FIG. 6, the data capture operation 508 is described in more detail in accordance with an embodiment of the prior art improvement. Specifically, FIG. 6 illustrates a collection of operational characteristics embodying a process 600 for storing interactive data and activity data captured during a service session to a media file. As with FIG. 5, the storage process is described with reference to the interactive data being voice communications (contained in packets) and the activity data is described with reference to the activity data being video data (captured by the video capture device 210) in accordance with an exemplary embodiment of the prior art improvement. The storage process 600 is initiated at the conclusion of the create operation 506 and is practiced using an operation flow that starts with a transfer operation 602. The transfer operation 602 transfers the operation flow of the recording process 500 to the operation flow of the storage process 600. From the transfer operation 602, the operation flow initially proceeds to an activate operation 604.

The activate operation 604 activates the video capture device 210 communicatively connected to the agent terminal 206 assigned to the selected customer service representative, thereby initiating video recording of the service session. From the activate operation 604, the operation flow passes to a count operation 606. The count operation 606 selects an initial time reference for the service session (e.g., 0 seconds) and initiates a counting procedure to measure the amount of time elapsed during recording of the service session.

With the counting initiated, the operation flow passes in substantially concurrent fashion to a video receive operation 608 and an audio receive operation 610. The video receive operation 608 begins receiving the video data captured by the video capture device 210 and storing the received video data to memory on the agent terminal 206. Likewise, the audio receive operation 610 begins copying the audio data from the payloads of incoming and outgoing packets 203 and storing the received audio data to memory on the agent terminal 206. With the reception of both forms of data still being accomplished, the operation flow passes (again, in substantially concurrent fashion) from the video receive operation 608 and the audio receive operation 610 to a first query operation 612.

The first query operation 612 determines whether the service session being recorded is complete. Such a determination may be made by analyzing signaling information embodied in the packets 203 to detect an “end of call” designation or other like indicia. If the service session is complete, the operation flow passes to conclude operation 613, which, in a general sense, halts both the video receive operation 608 and the audio receive operation 610. To accomplish this, the conclude operation 613 de-activates the video capture device 210 and concludes the discovery of audio data within any incoming or outgoing packets (though, at the conclusion of the session, it should be understood that few to no packets 203 will be transmitted to or from agent terminal 206 to the ACD module 108). From the conclude operation 613, the operation flow passes to a video package operation 616, which is described below. If, however, the service session is not complete, the operation flow passes from the first query operation 612 to a second query operation 614.

The second query operation 614 determines whether the count from the initial time reference (with respect to the first iteration) or the conclusion of the previous time interval (with respect to the subsequent iterations) has reached a specified interval that corresponds to the predetermined size specified for the video and audio segments. If the specified interval has not been reached, the operation flow passes back to the first query operation 612 and continues in a loop between the first query operation 612 and the second query operation 614 until either (1) the session is ended; or (2) the end of the specified interval has been reached. At the end of the specified interval, the operation flow is passed from the second query operation 614 to the video package operation 616. Again, the reception of video and audio data initiated by the video receive operation 608 and the audio receive operation 610 is maintained even with the operation flow passing away from the second query operation 614.

The video package operation 616 retrieves the video data that has been received and stored in memory of the agent terminal 206 since the initiation of the counting (with respect to the first iteration) or the previous time interval (with respect to subsequent iterations) and packages the video data into a segment of predetermined size, as described above. From the video package operation 616, the operation flow passes to an audio package operation 618. Similarly, the audio package operation 618 retrieves the audio data that has been received and stored in memory of the agent terminal 206 since the initiation of the counting (with respect to the first iteration) or the previous time interval (with respect to subsequent iterations) and packages the audio data into a segment of the same predetermined size.

It should be appreciated that the order of operation of the video package operation 616 and the audio package operation 618 is illustrative only and, that in accordance with other embodiments, the order of operation may be reversed or performed substantially simultaneously. Regardless of the implementation, after both the audio data and the video data have been segmented, the operation flow passes to a synchronize operation 620.

The synchronize operation 620 saves the audio segment created by the audio package operation 618 and the video segment created by the video package operation 616 to the media file created by the create operation 506 in association with one another according to a common time reference, as illustrated in the representation 300 shown in FIG. 3 in accordance with an exemplary embodiment. Saved in this manner, playback of the audio segment will be synchronized with playback of the video segment. From the synchronize operation 620, the operation flow passes to a third query operation 622, which determines whether the first query operation 612 determined the session to be complete or incomplete. It should be appreciated that the third query 622 does not determine whether the session is complete or incomplete by itself, but rather relies on the decision by the first query operation 612 due to the maintenance of reception of audio and video data during the package operations 616, 618 and the synchronize operation 620 (if the first query operation 612 indeed determined the session to not be complete).

If the first query operation 612 determined the service session to be complete, the third query operation 622 passes the operation flow to a second transfer operation 624. The second transfer operation 624 transfers the operation flow back to the recording process 500, which resumes at the upload operation 510. Otherwise, the operation flow passes from the third query operation 622 back to the second query operation 614 and the storage process 600 continues to further store (and synchronize) audio data and video data to the media file, as previously described.

Turning now to FIG. 7, a process 700 for monitoring interaction between a customer and a customer service representative in substantially real-time is shown in accordance with an embodiment of the prior art improvement. With reference to FIG. 2, this embodiment involves a user (e.g., supervisor) operating the server computer 222 to monitor a customer service session as the session occurs. The monitoring operation is initiated with a start operation 702 and concludes with a terminate operation 720. Again, consistent with the exemplary descriptions above, the monitoring process 700 is described herein with reference to the monitoring system 200 shown in FIG. 2 as well as the exemplary embodiment in which the recorded interactive data embodies audio data exchanged between the customer and the customer service representative during the session and the recorded activity data embodies video data documenting physical movements and actions by the representative during the session.

The start operation 702 is initiated in response to the agent terminal 206 being selected for recording, at which time the operation flow passes to an initiate operation 704. The initiate operation 704 activates the interactive recording device 230 for capturing the audio communications between the customer and the customer service representative and the activity recording device 232 for capturing the video data from the video capture device 210. From the initiate operation 704, the operation flow passes to a query operation 706. The query operation 706 determines whether the session is complete and, if so, passes the operation flow to a de-activate operation 708, which de-activates the interactive recording device 230 and the activity recording device 232. The operation flow then concludes at the terminate operation 720.

If, however, the query operation 706 determines that the session is not complete, the operation flow is passed substantially simultaneously to receive activity data operation 710 and an interactive data receive operation 712. The receive activity data operation 710 captures the video data recorded by the video capture device 210 and the interactive data receive operation 712 captures the audio data carried in the payload of the packets 203 that are incoming and outgoing to/from the agent terminal 206. From the receive activity data operation 710 and the interactive data receive operation 712, the operation flow substantially simultaneously passes to an activity data transmit operation 714 and an interactive data transmit operation 716, respectively.

The activity data transmit operation 714 writes the received video data to a publishing point, which in an embodiment is a software module or component of the monitoring module 202 that may be subscribed by a user of the server computer 222 to monitor sessions in real-time. Likewise, the interactive data transmit operation 716 writes the received audio data to the publishing point. From both the activity data transmit operation 714 and the interactive data transmit operation 716, the operation flow passes substantially simultaneously to a stream operation 718, which streams the published video data and audio data to the server computer 222, which is operated by a user (e.g., supervisor) to monitor the session in real-time. From the stream operation 718, the operation flow passes back to the query operation 706 and continues as previously described.

While a VOIP soft phone 208 is described for use with the monitoring system 200, it should be appreciated that other types of phones may be utilized. In which case, the agent terminal 206, while still using the packets 203 for the purposes noted above, would convert the packets 203 to the proper format (e.g., digital, analog, etc.) for interpretation by such an alternative phone type.

Furthermore, while the PSTN 104 is shown in FIG. 2 and described in conjunction therewith in accordance with an exemplary environment of the prior art improvement, it should be appreciated that alternative communication networks may be employed between the ACD module 108 and the customer's telephone 102. For example, the PSTN 104 may be replaced or supplemented with a packet-switched network. If so, the ACD module 108 may be relieved of the task of converting call information to the packet-based format, as described in conjunction with FIG. 2.

Additionally, while the various forms of recorded interactive data and recorded activity data are described herein as being stored together (with associated time references) in the same media file, an alternative embodiment involves these two forms of recorded data being stored in separate files while still being associated based on common time reference. For example, the audio data segments 302 shown in FIG. 3 may actually reside in a separate media file than the video data segments 304. However, the representation 300 of FIG. 3 still applies in that each of the video data segments 304 (and, thus sub-segments) are associated with a video data segment 304 based on a common time reference 306. Indeed, the location of the physical storage of the individual segments 302 and 304 is irrelevant in accordance with this embodiment so long as each audio segment 302 is associated with a video segment 304 using a common time reference 306.

The detailed description below describes improvements to the above-described systems.

### BRIEF DESCRIPTION OF THE SEVERAL VIEWS OF THE DRAWINGS

FIG. 1 illustrates a prior art system for monitoring interaction between a customer service representative and a customer.

FIG. 2 illustrates a prior art system for monitoring interaction between a customer service representative and a customer.

FIG. 3 depicts a representation of the relation between recorded interactive data and recorded activity data in a media file created using the prior art monitoring system shown in FIG. 2.

FIG. 4 depicts an exemplary computing environment upon which embodiments of the prior art system may be implemented.

FIG. 5 is a flow diagram illustrating operational characteristics of a prior art process for monitoring interaction between a customer service representative and a customer.

FIG. 6 is a flow diagram illustrating operational characteristics of the prior art monitoring process shown in FIG. 5 in more detail.

FIG. 7 is a flow diagram illustrating operational characteristics of a prior art process for monitoring interaction between a customer service representative and a customer in substantially real-time.

FIG. 8 shows the overall eyeQ360 system in an embodiment of the present invention.

FIG. 9 shows a block diagram of one aspect of the phone interaction capture process in an embodiment of the present invention.

FIG. 10 shows a block diagram of another aspect of the phone interaction capture process in an embodiment of the present invention.

FIG. 11 shows a block diagram of a web application in an embodiment of the present invention.

FIG. 12 shows a block diagram of an eyeQ360 API in an embodiment of the present invention.

FIG. 13 shows a block diagram of another aspect of the phone interaction capture process in an embodiment of the present invention.

FIG. 14 shows a block diagram of an audio remote recorder that utilizes audio capture boards that interact directly with a telephony switch in an embodiment of the present invention.

FIG. 15 shows a block diagram of an audio remote recorder that utilizes network interface cards that interact directly with an audio gateway in an embodiment of the present invention.

FIG. 16 shows a block diagram of an audio remote recorder that utilizes telephony switch libraries that interact directly with a telephony switch in an embodiment of the present invention.

FIG. 17 shows a block diagram of the video capture process in an embodiment of the present invention.

FIG. 18 shows a block diagram of a video remote recorder in an embodiment of the present invention.

FIG. 19 shows a block diagram of generating media files from captured audio and video data in an embodiment of the present invention.

FIG. 20 shows a block diagram of a supervisor receiving a streaming session of an agent in an embodiment of the present invention.

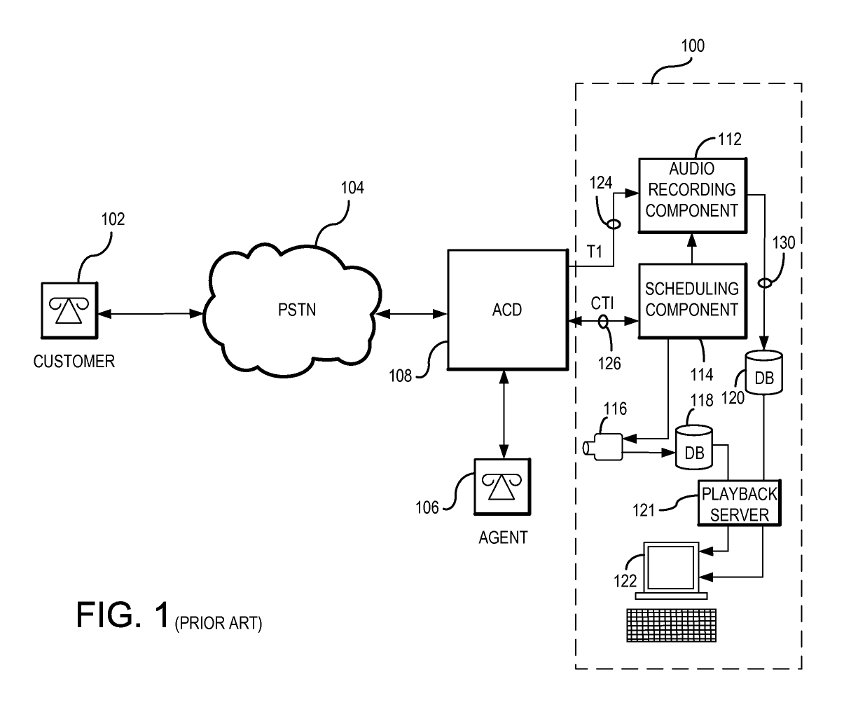

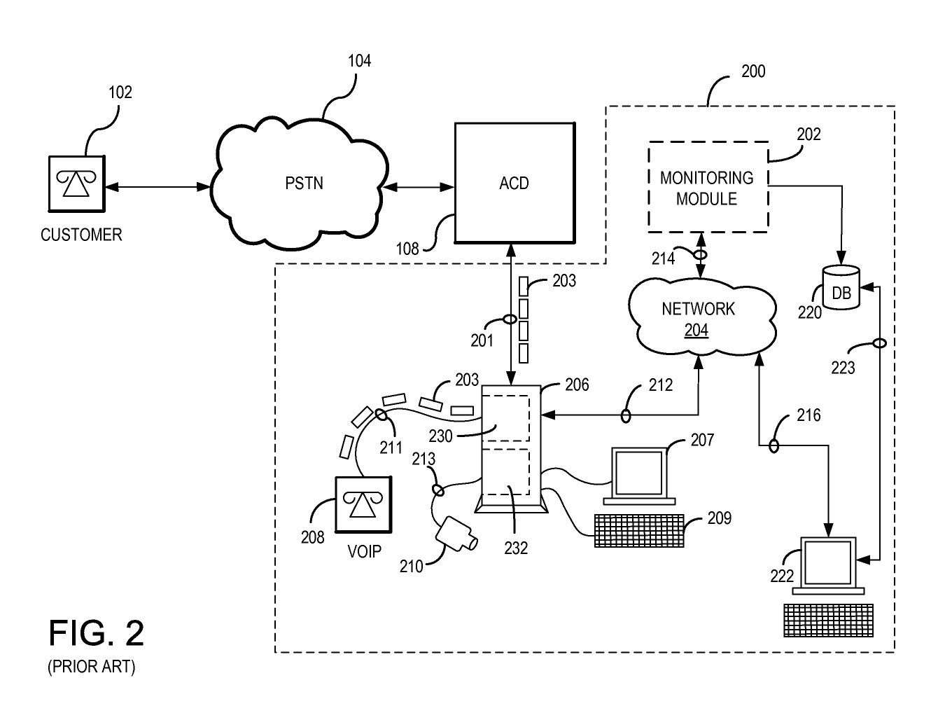

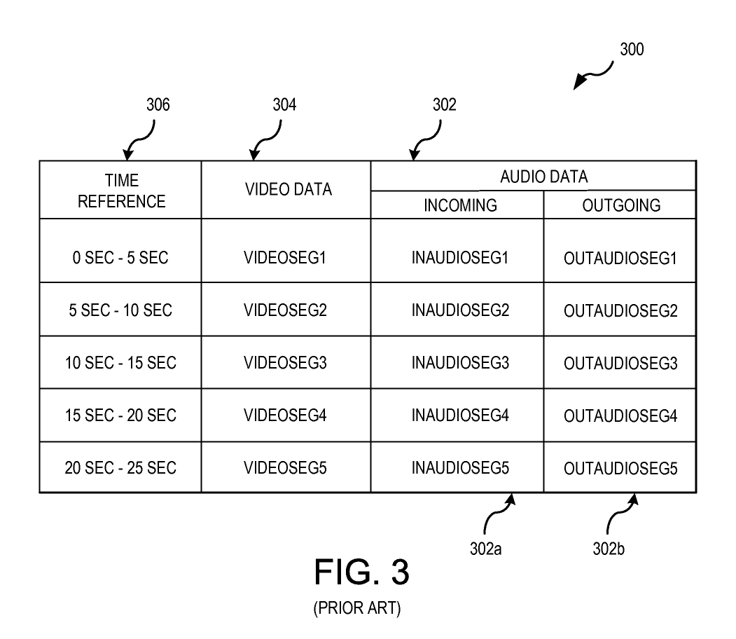

### DETAILED DESCRIPTION

The invention may be implemented as a computer process, a computing system, or as an article of manufacture such as a computer program product. The computer program product may be computer storage medium readable by a computer system and encoding a computer program of instructions for executing a computer process. The computer program product may also be a propagated signal on a carrier readable by a computing system and encoding a computer program of instructions for executing a computer process.

The invention may also be practiced as a method, or more specifically as a method of operating a computer system. Such a system would include appropriate program means for executing the method of the invention.

Also, an article of manufacture, such as a pre-recorded disk or other similar computer program product, for use with a data processing system, could include a storage medium and program means recorded thereon for directing the data processing system to facilitate the practice of the method of the invention. It will be understood that such apparatus and articles of manufacture also fall within the spirit and scope of the invention.

With the computing environment in mind, embodiments of the present invention are described with reference to logical operations being performed to implement processes embodying various embodiments of the present invention. These logical operations are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts, components, or modules. It will be recognized by one skilled in the art that these operations, structural devices, acts, components, or modules may be implemented in software, in firmware, in special purpose digital logic, and any combination thereof without deviating from the spirit and scope of the present invention as recited within the claims attached hereto.

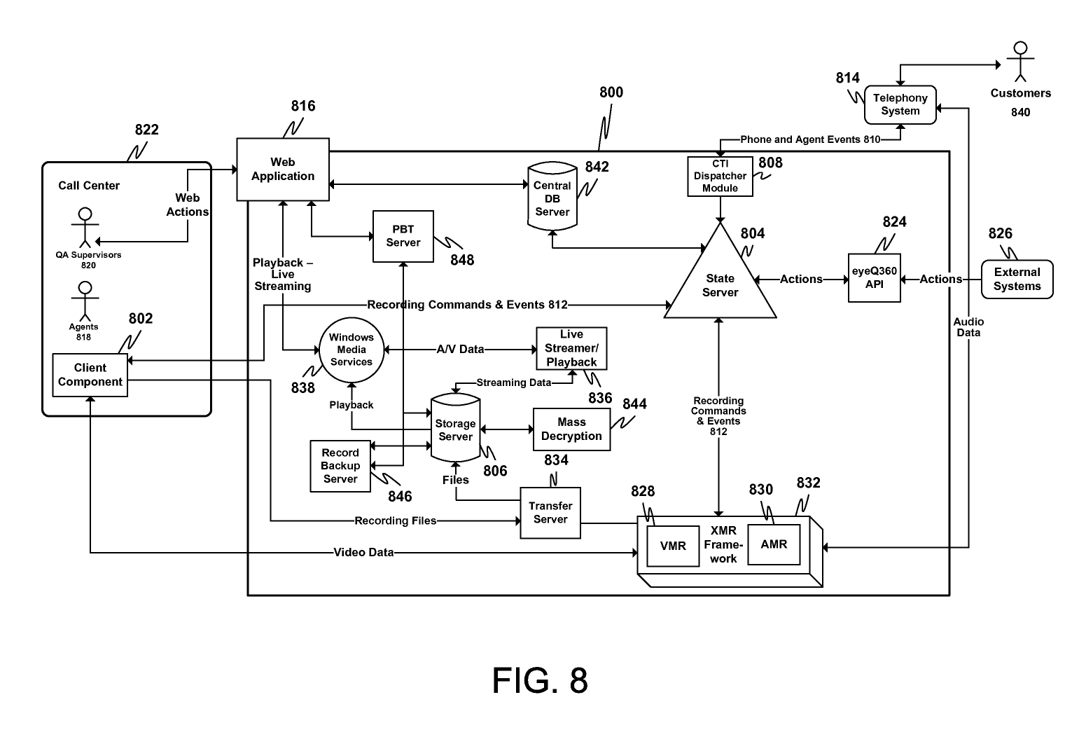

Referring now to the Figures, in which like reference numerals refer to structurally and/or functionally similar elements thereof, FIG. 8 shows a block diagram of the overall system in an embodiment of the present invention. Referring now to FIG. 8, eyeQ360 System 800, also referred to simply as eyeQ360, consumes Phone And Agent Events 810 on which logic is applied to decide whether to record the interaction or not. The recording takes place by capturing the audio and video. Finally, both parts (audio and video) are merged to a single multimedia recording file and moved to a Storage Server 806.

The Phone And Agent Events 810 are captured in several different ways:

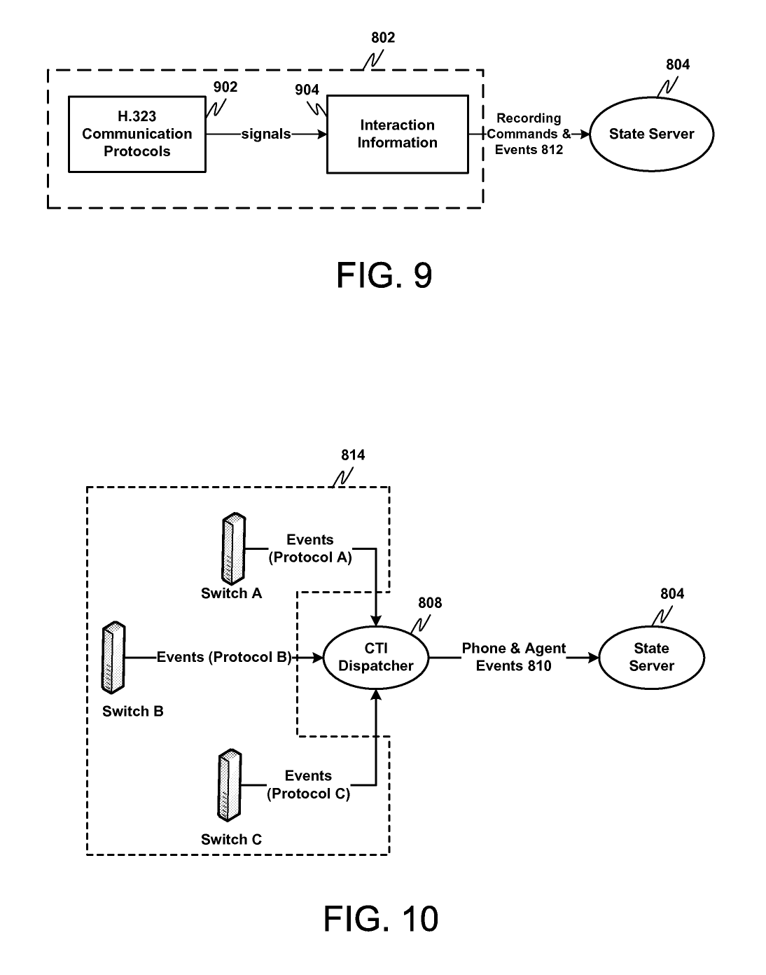

1. Referring now to FIG. 9, one aspect of the capture process takes advantage of the Standard H.323 Protocols 902 to capture phone Interaction Information 904 from Client Component 802 without hardware integration or traditional network packet sniffing. In order to obtain both the Interaction Information 904 and the phone line status, Client Component 802 captures and analyzes the Standard H.323 Protocols 902 exchanged between the IP soft phone and the IP switch and sends these Recording Commands And Events 812 to State Server 804.

2. Referring now to FIG. 10, another aspect of the retrieval process captures Phone And Agent Events 810 directly from the Telephony System 814 through the provided APIs. The Phone And Agent Events 810 are published for later use by this or any other application. The State Server 804, which is the brain of eyeQ360 System 800, subscribes to the CTI (Computer Telephony Integration) Dispatcher Module 808. The CTI Dispatcher Module 808 provides a common interface from where other modules or components of eyeQ360 System 800 can subscribe. When a subscription is made, the CTI Dispatcher Module 808 will automatically start sending the processed events to the subscribers.

The CTI Dispatcher Module 808 or Client Component 802 will communicate about the Phone And Agent Events 810 being generated in Call Center 822. The following information will also be retrieved from Telephony System 814: Automatic Number Identification (ANI), Dialed Number Identification Service (DNIS), Call Direction, etc. With respect to Phone And Agent Events 810, examples of Agent Events include Login, Logout, Ready, NotReady, etc. Examples of Phone Events include Ringing, Dialing, Talking, Hold, Retrieve, Release, Transfer, Conference, etc.

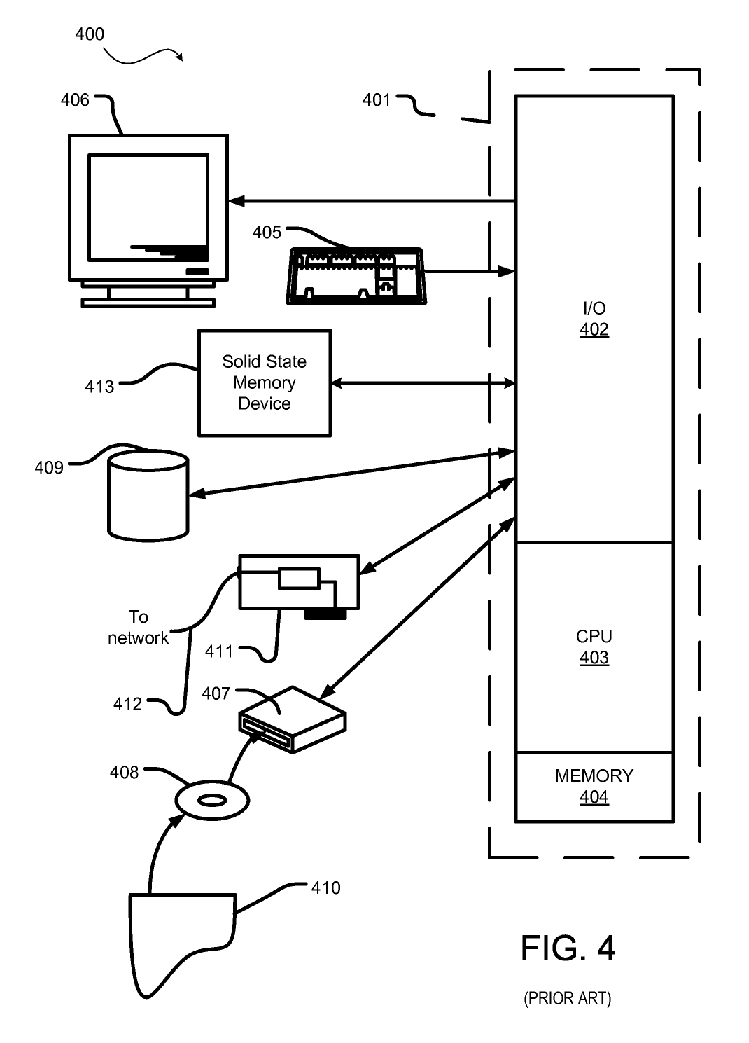

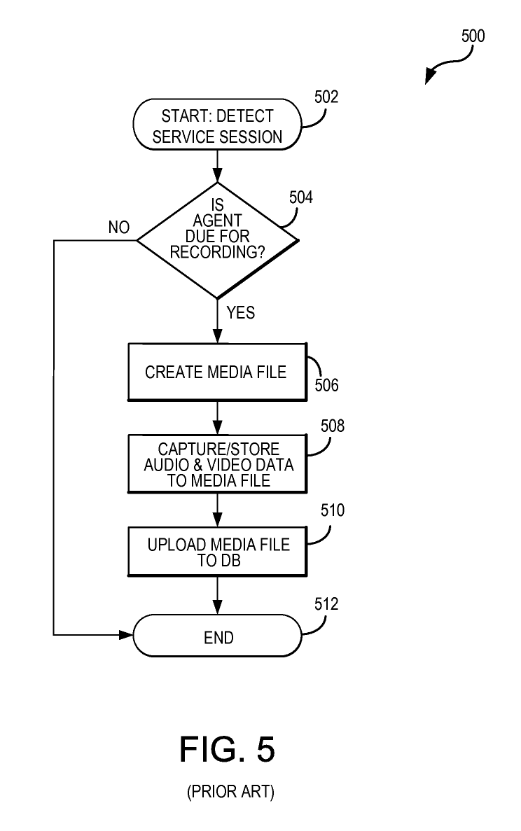

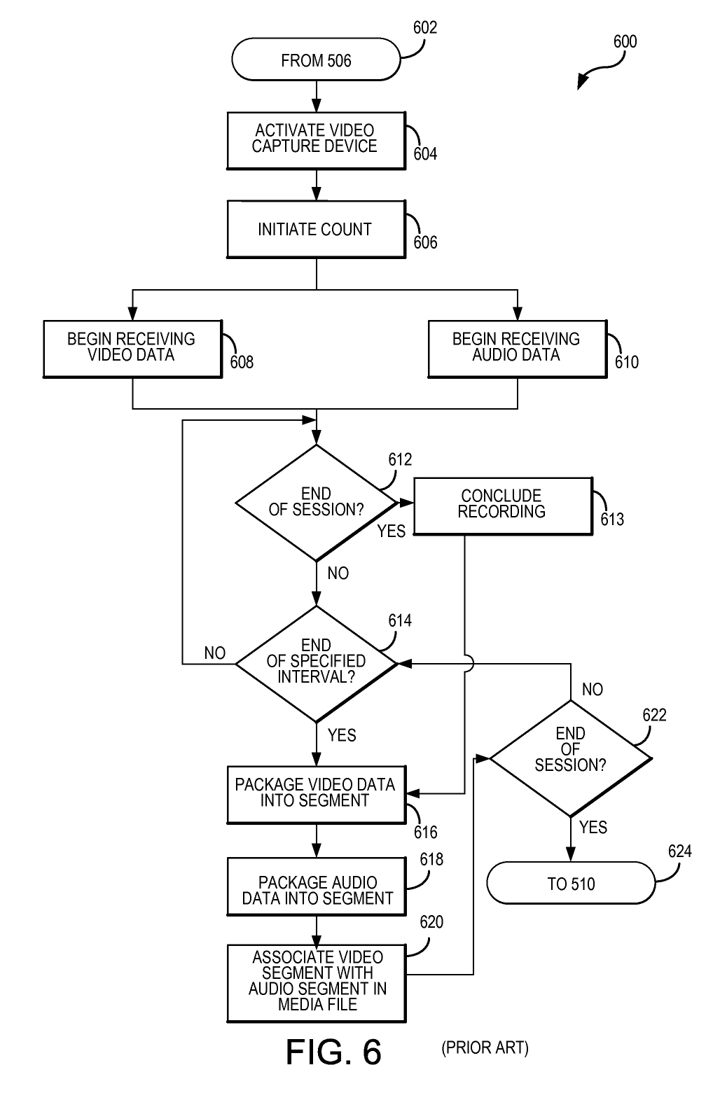

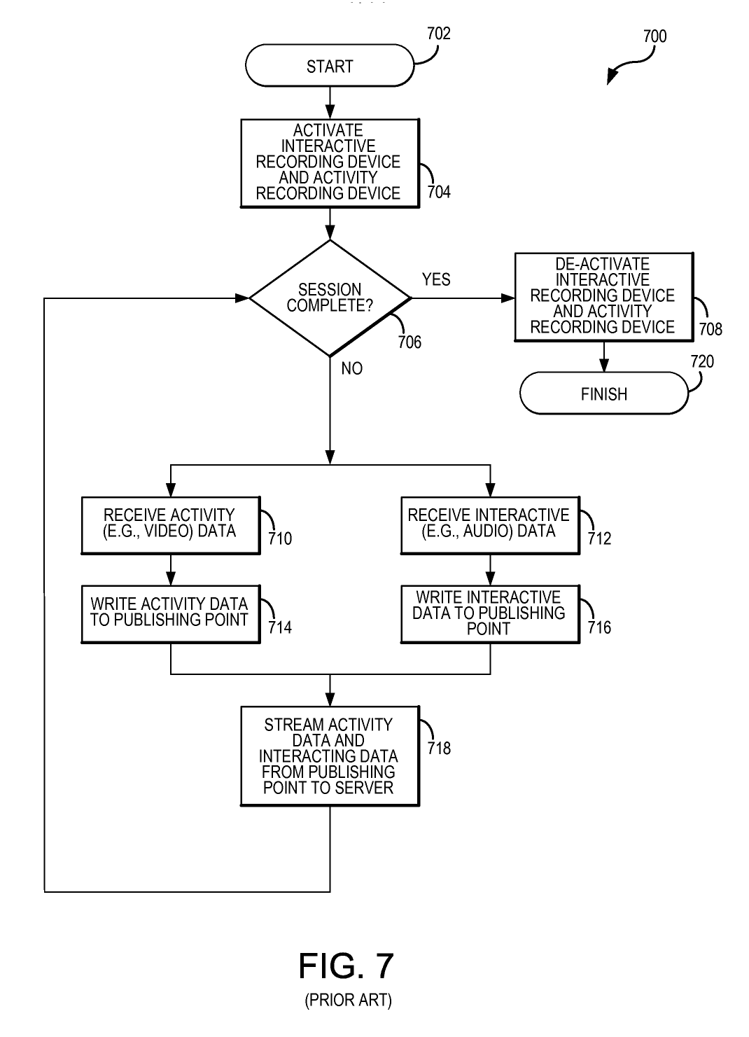

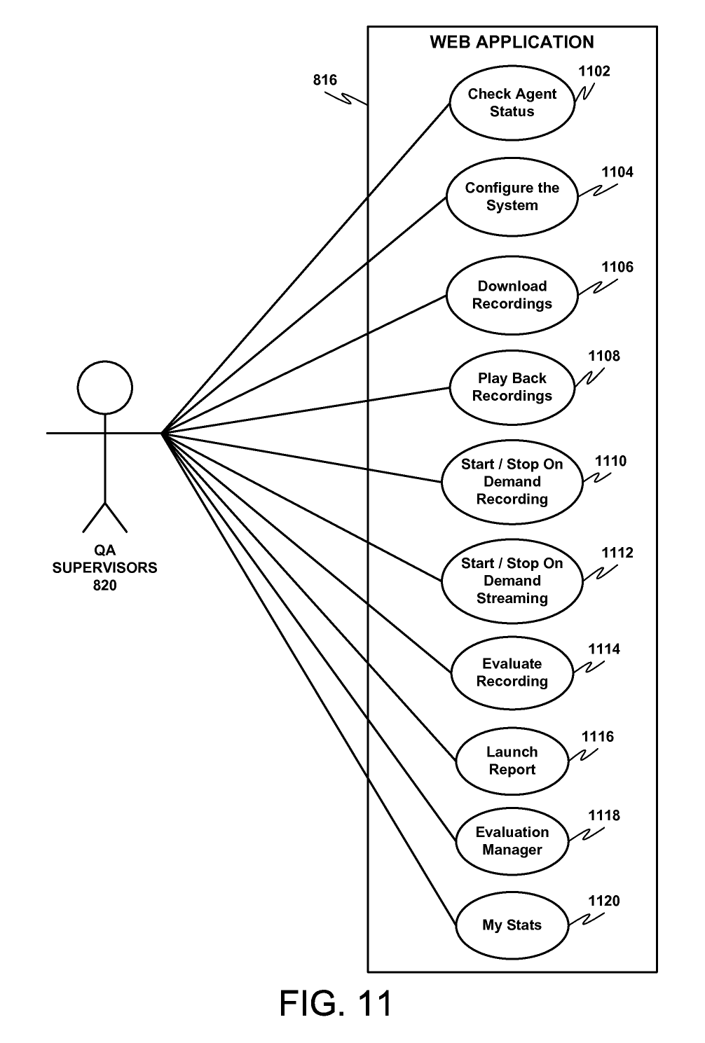

Referring now to FIG. 11, QA Supervisors 820 of eyeQ360 System 800 can access Web Application 816 from their workstations and perform numerous tasks. QA Supervisors 820 workstation may be similar to that described in reference to FIG. 4. Web Application 816 presents a web page where QA Supervisors 820 can access and see the status of all Agents 818 and other functionalities such as: Check Agent Status 1102, Configure The System 1104, Download Recordings 1106, Play Back Recordings 1108, Start/Stop On Demand Recording 1110, Start/Stop On Demand Streaming 1112, Evaluate A Recording 1114, and Launch A Report 1116, and Evaluation Manager 1118, and My Stats 1120.

Some exemplary tasks are described below:

1. Web Application 816 allows QA Supervisors 820 to completely manage the performance of Agents 818, sometimes also referred to as customer service representatives (CSRs). Web Application 816 includes an intuitive and very flexible form edition section that allows the creation of forms to evaluate the Agents 818 performance during their interactions with Customers 840. These forms can be fully customized to meet each program's needs. They include, but are not limited to, negative and bonus points, AutoFailures, Not Applicable sections, and allow the possibility to set up a median score in order to easily determine the Agents 818 strengths and weaknesses. All these evaluations are managed from Web Application 816. These evaluations can be approved or disapproved by QA Supervisors 820, or even marked for calibration, in order to further discuss the evaluation with the specific QA Supervisor 820 who performed the evaluation. Also, to help improve organization, these evaluations could be marked as coached once the Agents 818 receive feedback from the QA Supervisors 820 who performed the evaluation.

2. To help organize all this information, Web Application 816 includes a My Stats 1120 module. This web page includes information such as the number of incomplete evaluations, evaluations pending for calibration, how many were coached, approved, disapproved, etc.

3. All this information can be gathered by different reports. There are nine different categories and each of them has several different types or reports adding up to 25 reports. All of the reports can be run on a program, project, or even at the agent level. The My Stats 1120 module allows the user to easily obtain precise and concise information.

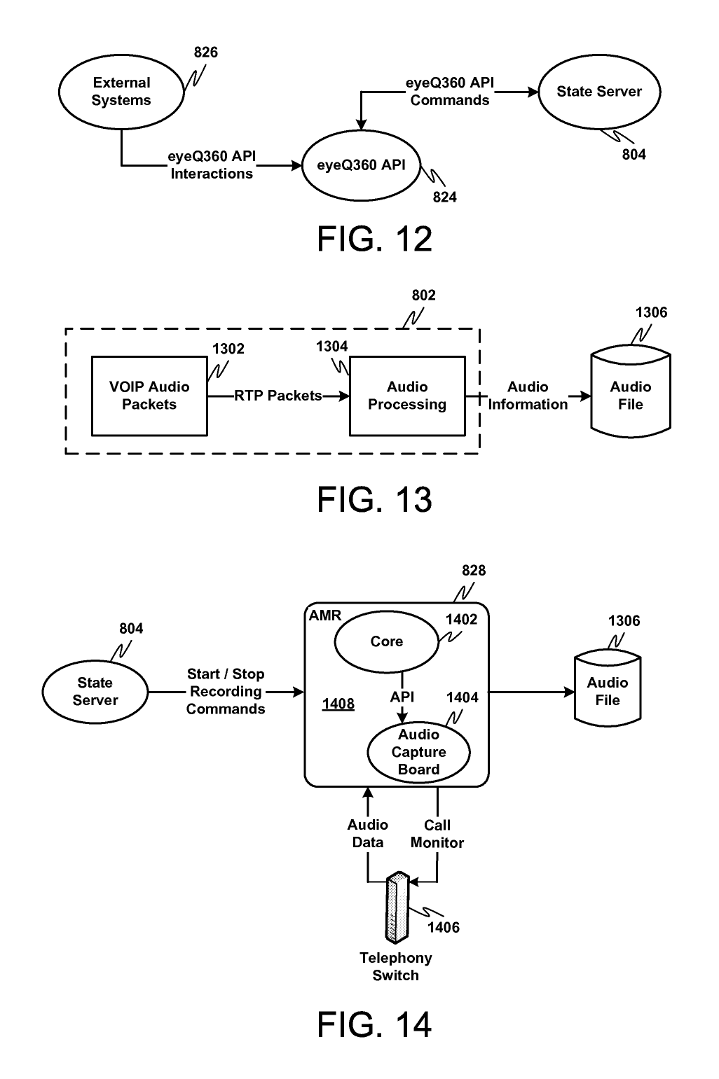

Referring now to FIG. 12, eyeQ360 API 824 is an interface where Web Application 816 can get connected and interact with other components/modules of eyeQ360 System 800. eyeQ360 API 824 is used to start/stop recording any customer/agent interaction whenever it is needed, even if the call is being recorded by a recording rule. Calls can be recorded as audio only, video only, or both audio and video. There are numerous other tasks such as: get a current eyeQ360 recording ID, get the agent status, etc.

State Server 804 can trigger a recording under various conditions. The process for making a decision whether or not to start a recording is based on what QA Supervisors 820 have previously configured in the eyeQ360 System 800. There are several different rule types which can be handled by State Server 804:

1. Agent 818 takes a call and the associated project rule demands recording that call. State Server 804 allows configuring the rule's recording percentage at the customer level or at the agent level. The rules can demand to record audio only, video only, or both.

2. QA Supervisors 820 selects “start an on demand recording” through Web Application 816.

3. An External Systems 826 requires “start an on demand recording” through eyeQ360 API 824.

4. A special type of rule called “Block of Time Recording” is enabled. This rule requires an Agent 818 to be recorded during certain periods of time. If in a specific moment this rule applies, State Server 804 will trigger a start recording command.

The audio and the video information are important for eyeQ360 System 800 and serve as the raw materials used to create a recording. The audio and video may come from different places as described below.

1. Referring now to FIG. 13, Client Component 802 can capture the VoIP Audio Packets 1302 in the same format that the IP soft phone exchanges them with the switch. Audio Processing 1304 processes the RTP packet formatted audio information into Audio File 1306.

2. Referring now to FIG. 14, AMR Recorder (Audio reMote Recorder) 828 has an Audio Telephony Hardware Recorder Component 1408 that captures the audio into Audio File 1306 through Core 1402 and Audio Capture Boards 1404 that interact directly with the Telephony Switch 1406. Core 1402 receives events from State Server 804 about which calls to record and sends a request to Telephony Switch 1406 to observe the call.

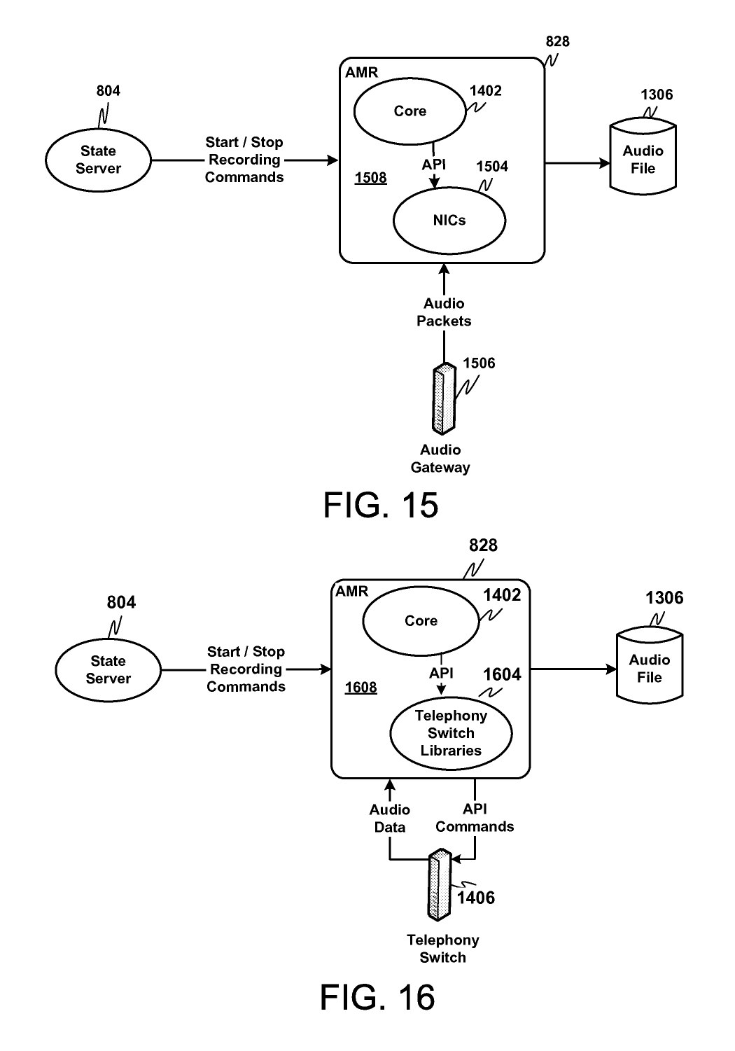

3. Referring now to FIG. 15, AMR Recorder 828 has an Audio Gateway Recorder Component 1508 that captures the audio into Audio File 1306 through Core 1402 and Network Interface Cards 1504 that interact directly with the Audio Gateway 1506.

4. Referring now to FIG. 16, AMR 828 has an Audio Telephony Software Recorder Component 1608 which captures the audio into Audio File 1306 through Core 1402 and Telephony Switch Libraries 1604 that interact directly with the Telephony Switch 1406.

Video recorders are able to record the video information from different places as described below.

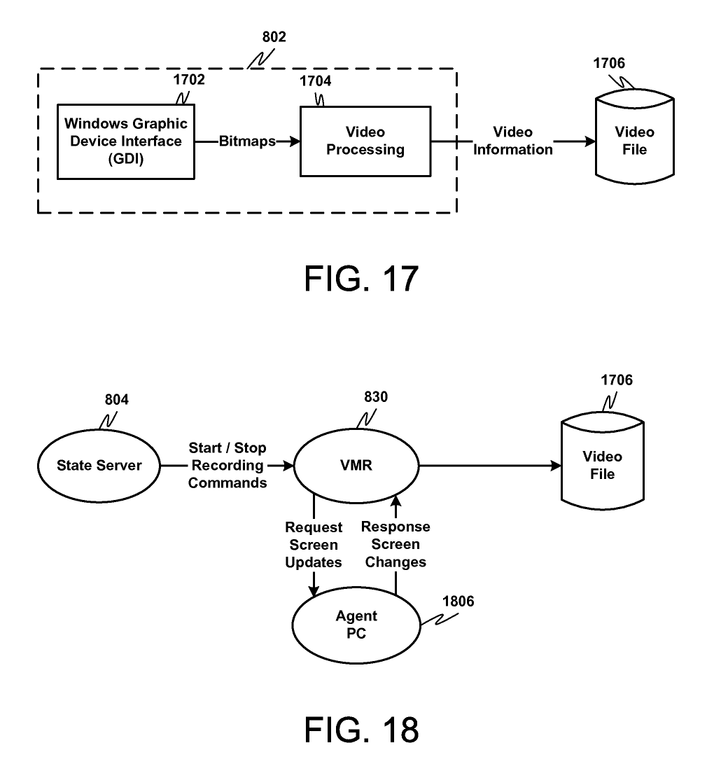

1. Referring now to FIG. 17, Client Component 802 can capture screenshots of the modified screen sections informed by a video driver through Windows Graphic Device Interface 1702. A custom video driver improves this functionality. Video Processing 1704 processes the bitmaps into Video File 1706.

2. Referring now to FIG. 18, VMR Recorder (Video reMote Recorder) 830 is a centralized module that connects to the Agent PC 1806 through a protocol for remote access to graphical user interfaces, and captures the screenshots into Video File 1706. Agent PC 1806 may be similar to that described in reference to FIG. 4.

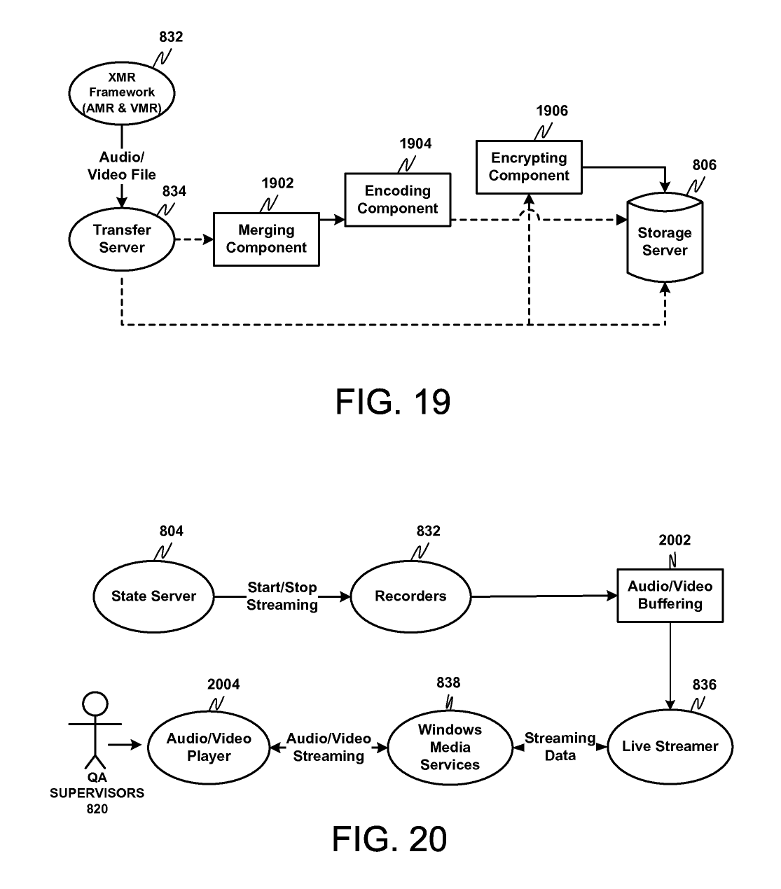

Referring now to FIG. 19, XMR Framework 832 (each of AMR Recorder 828 and VMR Recorder 830) send the respective captured information to Transfer Server 834. XMR Framework 832 handles all the operations shared between the Transfer Server 834 will merge the audio and video information and post the resulting formatted file to a centralized Storage Server 806. These generated media files are accessible by Web Application 816.

After Merging Component 1902 is completed, it might be required to re-encode the merged recording using a well-known codec through Encoding Component 1904. Or, instead, the merged recording will not be re-encoded and an eyeQ360 Codec Component will need to be installed on the QA Supervisors 820 workstation in order to play the merged recording back. The eyeQ360 Codec Component will process the information which was saved as it was formatted originally in the capturing process. The merged recording files can also be encrypted for security purposes through Encrypting Component 1906. This is done with AES (Advanced Encryption Standard) and RSA algorithms and the merged recording files are kept encrypted along the whole process, even when they are played back in the Web Application 816. Also the interaction information is updated into Central Database Server 842 in order to keep track of the merged recording life-cycle.

QA Supervisors 820 can request monitoring of a specific Agent 818 interaction at any time. Through Web Application 816, QA Supervisors 820 can watch almost in real-time what the specific Agent 818 is doing. Thus, QA Supervisors 820 can monitor how the specific Agent 818 is assisting the Customers 840, what the Agent 818 is writing in the support ticket historical system, etc.

Referring now to FIG. 20, when QA Supervisors 820 want to monitor an Agent 818, State Server 804 will look up if there is an active streaming session for that Agent 818. If so, State Server 804 will make use of that streaming session. If not, State Server 804 will create a new streaming session and require XMR Framework 832 to send the audio or video information or both to Audio/Video Buffering 2002 and on to Live Streamer/Playback Server 836. Live Streamer/Playback Server 836 will queue all the arrived packets and publish a considerable amount of them through Windows Media Services 838 to be consumed by Audio/Video Player 2004.

The whole process involves different components distributed on the eyeQ360 System 800 network. This deployment can vary across Customers 840. The reason is that some Customers 840 can require a specific configuration (encryption, specific telephony switch, codec, firewall restrictions, etc.) and that will require different components or modules. Below is a list of many of the eyeQ360 System 800 components/modules not considering a specific implementation:

1. Client Component 802 installed on the same computer where the IP software phone is in order to capture audio, video and communicate Phone And Agent Events 810.

2. CTI Dispatcher Module 808 connects to different Telephony System 814 switches and retrieves the Phone And Agent Events 810 through the use of specific telephony APIs.

3. State Server 804 makes the decision on which phone interactions must be recorded.

4. Transfer Server 834 receives the audio and video captures from the different eyeQ360 XMR Framework 832.

5. Encrypting Component 1906 encrypts the recordings.

6. Live Streamer/Playback Server 836 plays back the recordings.

7. Web Application 816 accesses the recording catalog, agents' status, report launching, and evaluate recordings.

8. Encoding Component 1904 processes audio and video into a single video formatted file.

9. Live Streamer/Playback Server 836 monitors the audio and screen in real-time.

10. Encrypting Component 1906 reproduces encrypted files online.

11. Audio Gateway Recorder component within AMR Recorder 828 to record the audio packets at the audio gateway level.

12. Audio Telephony Hardware Recorder Component within AMR Recorder 828 records the audio packets through Audio Capture Boards 1404.

13. Audio Telephony Software Recorder Component within AMR Recorder 828 records the audio packets through the provided Telephony Switch Libraries 1604.

14. eyeQ360 Codec Component decodes the audio and video from non-encoded recordings.

15. VMR Recorder 830 records the video through a protocol for remote access to graphical user interfaces.

16. Record Backup Server 846 purges and backs up the recordings.

17. PBT (Purge Backup Tool) Server 848 is in charge of evaluating the purge and or backup rules definitions in order to execute them. Web Application 816 has a user interface where QA Supervisors 820 can program new purge and or backup rules. Once the rules are submitted the data is stored in the database. The PBT service on PBT Server 848 will read those rules and start moving files from one device to another or purging those files.

18. Mass Decryption Tool Component 844 massively decrypts required encrypted recordings. Mass Decryption Tool Component 844 can decrypt thousands of files at once. It uses a service account to gain access to the encryption keys. The service account and the server's information are hard coded in the DLLs. If someone were to steal the software they wouldn't be able to use it without having this information. Even if someone stole the server, they still wouldn't know the password as that is encrypted on the system.

19. Recording Player Component located on the QA Supervisors 820 workstation plays back the recordings.

20. Storage Server 806 stores the recordings.

Client Component 802 has the responsibility to:

1. Capture both received and sent TCP/IP packages using the Winsock Windows Application Interface.

2. Analyze TCP/IP packages following the TCP/IP RFC 1350 recommendations and a non-standard specification for H.323 communication protocols.

3. Send information about Agents 818 phone to State Server 804 (phone extension, windows user name and ACL login) once a login process is detected.

4. Send information about Agents 818 phone line status to State Server 804 (idle, ring, dial, hold, talk) once a status change is detected.

5. Send information about Agents 818 phone interaction to State Server 804 (call direction, Automatic Identification Number, Dialed Number Identification Service, disconnection source, interaction duration, etc.)

6. Capture and locally store the VoIP payload from RTP packages once a recording command is received from State Server 804.

7. Identify the screen changes by interacting with a video driver.

8. Capture and locally store the screen shots using GDI Windows Application Interface once a recording command is received from State Server 804.

9. Compress the GDI screen shots using the standard Rule-Length Encoding (RLE) specifications.

10. If the environment requires, turn the stored file (raw file) into a common multimedia formatted file.

11. Send the locally stored file (raw file) with the VoIP packages and compressed screen shots or the common multimedia formatted file using RFC 1350 recommendations.

12. Delete raw files or the common multimedia formatted file after the transfer is finished.

State Server 804 has the responsibility to:

1. Receive information from event provider components (Client Component 802 or CTI Dispatcher Module 808):

a. Agents 818 phone user information (phone extension, windows user name and ACL login number)

b. Agents 818 phone line status information (idle, ring, dial, hold, talk)

c. Agents 818 phone interaction information (call direction, Automatic Identification Number, Dialed Number Identification Service, disconnection source, interaction duration, etc.)

2. Receive external system command requests from eyeQ360 API 824.

3. Retrieve information about the Agent 818 phone user (customer center, user name and campaign) from Central Database Server 842 based on client phone information.

4. Update the internal line state with the phone line status information.

5. Make the decision about when a recording must be started based on the information received from Client Component 802 and the Central Database Server 842 information.

6. Send commands to XMR Framework 832 in order to:

a. Start voice and/or screen recordings;

b. Stop voice and/or screen recordings;

c. Pause voice and/or screen recordings;

d. Resume voice and/or screen recordings;

e. Cancel voice and/or screen recordings;

f. Start a voice and/or screen streaming session; and/or g. Stop a voice and/or screen streaming session.

7. Receive from XMR Framework 832 and Transfer Server 834 status of a transferring session.

8. Update in Central Database Server 842 the recording information including: recording number, recording centralized location, status and phone interaction information. The status column in Central Database Server 842 is updated by State Server 804. The status contains numerical values that indicate the state of the call, i.e., is it on the desktop, on a transfer server, failed to encode, failed to transfer, canceled the recording, or made it safely to storage.

CTI Dispatcher Module 808 has the responsibility to:

1. Interact with several different Telephony Switches 1406 using the provided telephony APIs.

2. Turn the specific formatted Telephony Switch phone/agent events into eyeQ360 Phone And Agent Events 810.

3. Provide an API so other components (including non-eyeQ360 components) can get subscribed and receive Phone And Agent Events 810.

Audio Gateway Recorder Component 1508 within AMR Recorder 828 has the responsibility to:

1. Process the Start/Stop/Resume/Pause Audio Recording methods.

2. Interact with Audio Gateway 1506.

3. Capture and locally store the forked audio packets.

4. Process the Start/Stop Audio Streaming methods.

5. Transfer the recordings as soon as it stops.

6. Delete raw files after the transfer is finished.

Audio Telephony Software Recorder Component 1608 has the responsibility to:

1. Process the Start/Stop/Resume/Pause Audio Recording methods.

2. Make use of the provided Telephony Switch APIs.

3. Register to the configured Telephony Switches 1406.

4. Capture and locally store the informed audio packets.

5. Process the Start/Stop Audio Streaming methods.

6. Transfer the recordings as soon as it stops.

7. Delete raw files after the transfer is finished.

Audio Telephony Hardware Recorder Component 1408 has the responsibility to:

1. Process the Start/Stop/Resume/Pause Audio Recording methods.

2. Manage Audio Capture Boards 1404.

3. Register the Audio Capture Boards 1404 to the corresponding Telephony Switches 1406.

4. Capture and locally store the informed audio packets.

5. Process the Start/Stop Audio Streaming methods.

6. Transfer the recordings as soon as it stops.

7. Delete raw files after the transfer is finished.

VMR Recorder 830 has the responsibility to:

1. Process the Start/Stop/Resume/Pause Video Recording methods.

2. Manage the Remote Video control protocol.

3. Control the configured frames per second.

4. Capture and locally store the informed audio packets.

5. Process the Start/Stop Video Streaming methods.

6. Transfer the recordings as soon as they stop.

7. Delete raw files after the transfer is finished.

eyeQ360 Codec Component has the responsibility to:

1. Provide the ability to watch recordings formatted by the capturing process.

2. Hook up with the Operating System Codec libraries on QA Supervisors 820 workstation.

3. Process the Recording Player Component command requests.

4. Decode the requested portions of encrypted recordings to a basic format which will be understood by the Recording Player Component.

5. Maximize the resources being consumed by the decoding process.

Encrypting Component 1906 has the responsibility to:

1. Make use of the AES and RSA encryption algorithms.

2. Generate random numbers with very low probability of collision.

3. Encrypt the whole recording file and communicate the generated encryption key.

4. Maximize the resources being consumed by Encrypting Component 1906.

5. Follow PCI (Payment Card Industry) rules and regulation to comply with their request.

Decryption Component is a plug-in located on Live Streamer/Playback Server 836 has the responsibility to:

1. Make use of the AES and RSA encryption algorithms.

2. Interact with Live Streamer/Playback Server 836 through a provided API.

3. Read the requested portion of encrypted file. The requests are managed by the Live Streamer/Playback Server 836.

4. Decrypt the requested portion of encrypted file. The requests are managed by the Live Streamer/Playback Server 836.

5. Follow PCI rules and regulations to comply with their request.

Record Backup Server 846 has the responsibility to:

1. Process the configured backup/purge rules.

2. Back up recordings if a configured rule applies.

3. Purge recordings if a configured rule applies.

4. Interact with an external drive if required.

5. Provide status regarding the process results.

Mass Decryption Tool Component 844 has the responsibility to:

1. Process the configured mass-decryption rules.

2. Make use of the Decryption Component XXX in order to decrypt the recording files.

3. Massively run parallel instances of the decryption process.

4. Interact with an external drive if required.

5. Provide status regarding the process results.

6. Provide a User Interface so QA Supervisors 820 can access and launch a mass-decryption process.

Live Streamer/Playback Server 836 has the responsibility to:

1. Make use of the Decryption Component XXX in order to decrypt the recording files if needed.

2. Access Storage Server 806 in order to read recording files.

3. Interact with the Recording Player Component. Provide the recording information to the Recording Player Component.

4. Manage all the concurrent Recording Player Component requests.

Live Streamer/Playback Server 836 has the responsibility to:

1. Process XMR Framework 832 connections and initiate and end live streaming sessions.

2. Buffer the received audio/video packets from XMR Framework 832.

3. Interact with the Recording Player Component.

4. Broadcast the buffered packets.

Encoding Component 1904 has the responsibility to:

1. Encode the media recording file to a well-known codec format if needed.

2. Run parallel Encoding Component 1904 process to maximize the resources being used by this operation.

3. Provide status regarding the process results.

Transfer Server 834 has the responsibility to:

1. Receive the media file transferring from XMR Framework 832 using TFTP RFC 1350 recommendations.

2. Store the received media files into a temporary folder.

3. Start Encoding Component 1904 if needed.

4. Start decryption process if needed.

5. Send information about the transfer status to State Server 804.

6. Send information about the encoding status to State Server 804.

7. Send information about the decryption status to State Server 804.

8. Move the final recording file to centralized Storage Server 806.

Web Application 816 offers QA Supervisors 820 the capability to:

1. Load on Central Database Server 842 information about what interaction must be recorded based on:
a. Phone interaction information;
b. Period of date/time; and
c. Phone user information (customer center name, customer campaign, user information).

2. Access media files through the information stored in Central Database Server 842.

3. Interact with the Live Streamer/Playback Server 836 in order to get a recording played back.

4. Download a recording file.

5. Start Recording Player session when QA Supervisors 820 want to watch a recording.

6. Show the current Agent 818 status.

7. Configure the system.

8. Launch reports.

9. Evaluate, calibrate and coach Agents 818.

Recording Player Component has the responsibility to:

1. Provide a User Interface to QA Supervisors 820 so they can interact with the Live Streamer/Playback Server 836.

2. Provide the ability to fast-forward the recording files.

3. Provide the ability to rewind the recording files.

4. Provide the ability to play back recording files.

5. Provide the ability to pause a recording file playback session.

6. Provide the ability to show the video belonging to the requested recording file.

7. Provide the ability to reproduce the audio belonging to the requested recording file.

8. Synchronize the audio and video information.

Storage Server 806 has the responsibility to:

1. Receive media files transferring from Transfer Server 834.

2. Store the received media files in a shared folder.

3. Accept connections from Live Streamer/Playback Server 836 to get the recordings played back.

4. Accept connections from Mass Decryption Component 844 to get the recordings decrypted massively.

5. Accept connections from Web Application 816 to get the recordings downloaded.

eyeQ360 System 800 supports different ways of recording Agents 818 interactions. The architecture is flexible and the system modules are plug-and-play based, meaning that there is no need to make any software adjustments to reconfigure the system to work with other modules or upgrades. New requirements will follow a standard process and a communication contract improving the application maintainability. eyeQ360 System 800 is capable of recording the audio and video interaction from Agents 818 working from his/her home. The information is encoded almost in real-time to make it available as soon as possible through Web Application 816.

eyeQ360 System 800 provides an Auto-Update Module, making upgrades easier and, therefore, decreasing the risks of human induced errors. The process has been refined to improve the system resources. This means that the application transmits more data over the business network, thus requiring less hardware to support the deployment.

To become a PCI compliant product, every recording has to be encrypted. This is done locally; therefore, the encrypted recordings remain encrypted during the transfer to Storage Server 806. The recording files also remain encrypted while being played back through Web Application 816 because they are decrypted in memory. The Live Streamer/Playback Server 836 caching is disabled for security reasons and when the file is decrypted in memory, Windows provides its own security. Encryption keys have been added to prevent a recording from being downloaded and openly viewed by anyone. To be able to play back a downloaded recording QA Supervisors 820 require the encryption key, and eyeQ360 Codec Component. The RED Tool module is a software component that is installed on QA Supervisors 820 workstation in the case where a file needs to be downloaded and manually decrypted. The QA Supervisors 820 would copy from the website the public key shown on the record being played back and paste it into the RED Tool module for it to properly decrypt the file.

eyeQ360 System 800 has been developed from scratch adding web 2.0 technologies and look and feel. The entire system has been upgrade from .Net 1.1 to .Net 4 allowing it to be faster and add the use of customized grids to show information. This brings up several advantages such as well-known user tools, personal customization of several pages, support on different hardware vendors, security authentication and authorization, and easy deployments. Web Application 816 contains wizards to the most complex modules such as reporting and evaluations.

The Report Module has improved logic that takes less time to gather the information from Central Database Server 842 and showing it on screen or exporting it to an Excel file. The Automatic Delivery Module allows subscribing to certain reports to be delivered daily, weekly, or monthly to the QA Supervisors 820 email address. The added reports give QA Supervisors 820 the possibility to easily determine areas of strength or development for Agents 818, Project, or Program perspective helping the QA team to plan their coaching and trainings. Also to minimize QA Supervisors 820 training, there is online help available with detailed information about every page and best practice tips. To further help QA Supervisors 820 with their experience, a Learning Center contains short five minute videos describing eyeQ360 System 800's most important features. There is also a Welcome Page that includes customizable charts containing useful information for every kind of user.

Evaluations have a new wizard that walk QA Supervisors 820 through the entire process. A Forms Designer utilizes drag-and-drop for faster form design. The whole process is centralized into single software, improving QA Supervisors 820 interaction, and unifying different departments' efforts in supporting eyeQ360 System 800.

eyeQ360 System 800 is able to record audio from hard phones via a first module, AMR Recorder 828, that connects directly to Audio Gateways 1506. Concurrently, Agents 818 computer screen is captured by a second module, VMR Recorder 830, which is a video remote recorder. These two modules generate two different files, audio and video, which are encoded into one to be played back. eyeQ360 System 800 not only handles Audio Gateways 1506, but is also able to get audio from hardware, telephony boards, and software, for example, soft phones. eyeQ360 System 800 also allows recording interactions on demand from Web Application 816. Users can start and stop these recordings at any time.

In order to reduce the use of bandwidth, eyeQ360 System 800 was designed to not use encoder servers. eyeQ360 System 800 encodes every recording locally and then transfers them several times smaller than the original file size, therefore, using less bandwidth and maximizing the storage capacity. These multimedia files are decoded by an eyeQ360 Codec Component when playing them back.

The Encoding Component 1904 process encrypts the recording, and coupled with other security enhancements, such as the web being able to work with encrypted sessions (HTTPS) enables eyeQ360 System 800 to be a PCI compliance product.

QA Supervisors 820 are able to monitor Agents 818 in real-time by live streaming their interactions through Web Application 816. This feature is enabled for every type of situation including when the Agents 818 are working from his/her home.

Management features such as the Evaluation and Reports Module have wizards that walk QA Supervisors 820 through the entire process. Evaluation forms are created via drag-and-drop to allow easy modifications while creating them.

eyeQ360 System 800 is an expansive solution not only including different options for recording Agents 818 interactions but also offering a package of different tools that help with the management of a Call Center. Without third party applications, Web Application 816 allows easy and fully customizable evaluation forms creation, wizards that help users find recordings and evaluate them. Reports can be run to obtain information, such as areas of strength and areas needing development to focus future coaching. The design enhances the user experience minimizing training and speeding up everyday tasks. To further improve user's knowledge about eyeQ360 System 800 there is online help available at any moment with detailed information of each page and best practice tips. Also, a Learning Center Module contains videos uploaded by eyeQ360 experts to explain in short five minute videos best uses of the eyeQ360 System 800 main features. The eyeQ360 System 800 can be integrated with other internally developed solutions to build integral Customer Care solutions for the clients.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A method for managing customer service representatives, the method comprising:
(a) recording an audio component and a video component of an interaction of the customer service representative with a customer;
(b) encrypting the recordings of the audio component and a video component;
(c) sending the encrypted recorded audio component and video component to a transfer server;
(d) merging by the transfer server the audio component and video component into a formatted file;
(e) posting by the transfer server the formatted file to a storage server;
(f) providing a web site to allow access by a user to the recordings; and
(g) playing back the recordings through a playback streamer server so the user can evaluate the interaction of the customer service representative with the customer.
